(19) United States
(12) Patent Application Publication
(10) Pub. No.: US 2011/0086188 A1
(43) Pub. Date: Apr. 14, 2011

(54) Tag material

(76) Inventor: Robert E. Williams, JR., Collinsville, IL (US)

(21) Appl. No.: 12/924,735

(22) Filed: Oct. 4, 2010

Related U.S. Application Data
(60) Provisional application No. 61/278,379, filed on Oct. 6, 2009.

(51) Int. Cl. B41M 5/50

(52) U.S. Cl. 428/32.39

(57) ABSTRACT

A reinforced two-side-printable laminate material constructed of a top layer of coated-one-side paper or related material, a middle layer of foamed polypropylene film or related material, and a bottom layer of paper material, said bottom layer being coated with a direct thermal emulsion with the thermal emulsion facing outward.

### CROSS REFERENCE TO RELATED APPLICATION

This non provisional patent application claims priority to the provisional patent application having Ser. No. 61/278,379, having filing date Oct. 6, 2010.

### FIELD OF THE INVENTION

The tag material of this invention relates to the use of laminate components which when adhesively adhered together form a tag type material that can be imprinted with various indicia and product information for use in the marketing of products to the trade.

### BACKGROUND OF THE INVENTION

This present invention provides a laminate tag material for use for any number of tag applications. The tag material is reinforced and printable on two sides, with one side being printable by a direct thermal printer.

Styles of tag material have been readily available in the art and for use for providing information relative to various marketed products. For example, paper tags have long been used in the art. Polymer type tags have become more prominent, because of their durability, and have now been designed for accepting print material. A combination of these types of components formulated into tag, has not apparently been to any extent, and therefore, providing a tags that is readily acceptable of print indicia, or other information, and yet is very durable during usage, and can withstand rough handling, is a welcome addition in the art.

### SUMMARY OF THE INVENTION

The tag material consists of three layers bonded by an adhesive. The first, or top, layer of the tag material is formed of paper or related material. The first layer is laminated or bonded by adhesive to the top face of the second, or middle layer. The second layer will typically be formed of a foamed polypropylene film for reinforcement, but it may also be formed of another polymer material depending on desired form and function. The third, or bottom, layer is formed of paper or related material that has been coated with a direct thermal emulsion, with the thermal emulsion facing outward. The third layer is laminated or bonded by adhesive to the bottom face of the second layer.

The resulting tag laminate is compatible with being printed on a direct thermal printer. The caliper of the finished material construction may vary, according to the desired use of the tag, by using differing calipers of constituent base materials.

### DESCRIPTION OF THE DRAWINGS

FIG. 1 is a perspective view of a section of the tag material, showing the three layers of the material bonded by layers of adhesive; and

FIG. 2 is a perspective view of a modified tag material also formed of three layers.

### DESCRIPTION OF THE PREFERRED EMBODIMENT

With reference to the drawings:

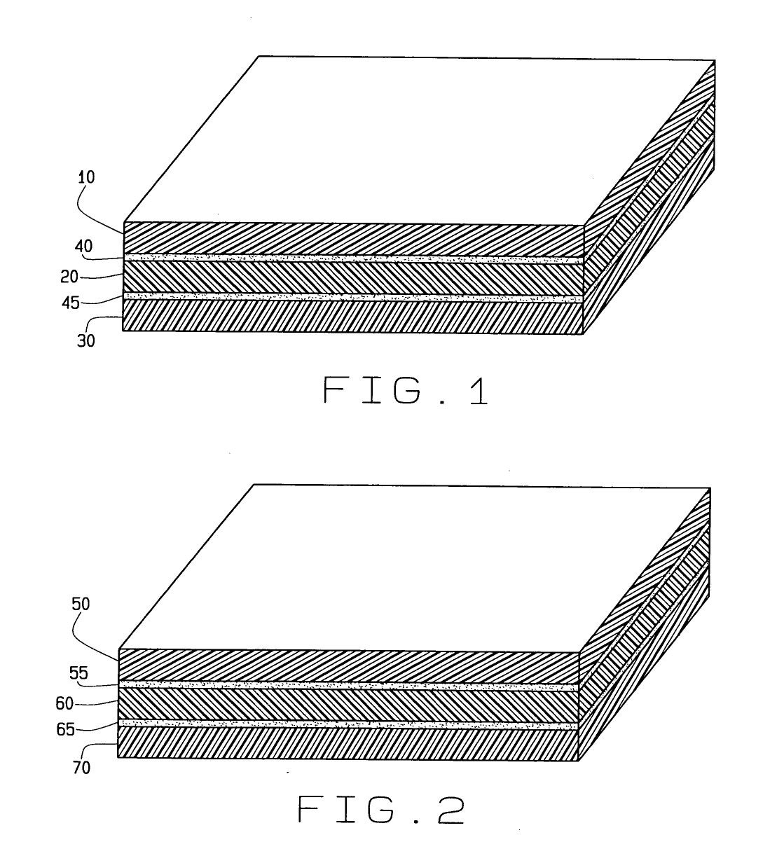

FIG. 1 is a perspective view of the tag material of the present invention. As can be seen and understood, the material is composed generally of three layers bonded by a laminating adhesive. The resulting laminate has a top face and a bottom face, as does each constituent layer in the laminate. In the preferred embodiment, top layer 10 is a coated-one-side (C1S) paper. Top layer 10 is bonded to middle layer 20 by a layer of bonding adhesive 40. In the preferred embodiment, middle layer 20 is a layer of foamed polypropylene. As noted, the middle layer 20 may also be of another polymer material, according to the intended use and application of the tag. Middle layer 20 provides reinforcement to the laminate. Bottom layer 30 is bonded by adhesive layer 45 to the bottom face of middle layer 20. In the preferred embodiment, bottom layer 30 is formed of paper that has been coated on its bottom face with a direct thermal emulsion.

By way of explanation, CSD is an acronym formed from the first letter of the description of each layer making up the tag material. C—Coated 1 Side Paper/S-Sheen (another name for the foamed polypropylene)/D—Direct Thermal Paper.

Thickness ranges of the three layers:

### Top Layer—2-4 mil

### Inner (Poly) Layer—1-6 mil

Bottom (thermal) Layer—2-5 mil

Thermal Emulsion- The direct thermal paper used on the CSD tags is commercially available direct thermal paper. We currently use Kanzaki brand 3.2 mil KIP-370 thermal paper though we have used other direct thermal papers in the past. There are a variety of foreign and domestic suppliers that catalog a number of direct thermal papers and films that could potentially be used for this application. Thermal emulsions and formulas are proprietary to the manufacturer.

Laminating Adhesive—We are currently using Airflex 426 water based laminating adhesive manufactured by Air Products. There are a variety of adhesive suppliers with various adhesive formulas that could be used for this type of lamination.

In a modification to this invention, and as shown in FIG. 2, the three layered tag is formed of material generally constructed of a top layer 50 formed of a clear polypropylene or related laminate material bonded to the emulsion side of a micro-encapsulated carbonless paper layer 60 being bonded by an adhesive 55, which paper layer 60 intern is bonded t the uncoated side of a coated 1 side (C1S) paper 70. This bonding also is attained by means of an adhesive 65. In referring to FIG. 2, the resulting construction is a laminated, two side printable tag material with both sides being printable by traditional printing methods such as flexo, of said, Rotgravure, and the like. Additional, the laminated micro-encapsulated side of the tag is capable of being imaged without the use of inks or dyes by either metal stamping or embossing the surface of the tag. The total tag caliber is reliant on the sum of the caliber of the three different layers and can be customized for specific applications by varying the calibers of one or more of the different components. In additional layer of clear laminate, as with the FIG. 1 embodiment, may be adhered to the coated side of the C1S paper for additional print protection.

This tag material of the current invention is designed for usage for a number of tag applications. The top layer of the tag will be formed of a clear laminate which intern is laminated or bonded with adhesive to emulsion side of a micro-encapsulated paper, which comprises the second on inner layer of the tag material. The second or inner layer is then laminated or bonded with adhesive to the uncoated side of the third or bottom layer, which is formed, as a foresaid, of the coated one side (C1S) paper. The laminated, micro-encapsulated surface of the tag creates the unique the feature of the resulting tag material that is capable of be printed without the use of inks or dyes by either metal stamping or embossing the surface of the tag.

Variations or modifications to the subject matter of this invention may occur to those skilled in the art upon reviewing the disclosure as provided herein. Such variations, within the spirit of this development, are intended to be encompassed within the scope of any invention as provided herein. The description of the preferred embodiment as set forth herein is done so for illustrative purposes only.

1. A material for making tags printable on two sides, said material comprising a laminate with a top face and a bottom face, said laminate comprising:
a top layer of paper material;
a middle reinforcing layer of foamed polypropylene film, said middle layer bonded to the bottom surface of said top layer by a layer of bonding adhesive applied between the top surface of said middle layer and said bottom surface of said top layer;
a bottom layer of paper material, said bottom layer having been coated with direct thermal emulsion, with said thermal emulsion facing outward so that it remains exposed, said bottom layer bonded to the bottom surface of said middle layer by a layer of bonding adhesive applied between the top surface of said bottom layer and said bottom surface of said middle layer.

2. The material of claim 1, wherein the middle layer is a polymer film of polyethylene.

3. A material for making tags printable on two sides, said material comprising a laminate with a top face and a bottom face, said laminate comprising a top layer of a clear laminate of polypropylene;
a middle layer of a micro-encapsulated carbonless paper, said middle layer bonded to the bottom surface of said top layer by a bonding adhesive;
a bottom layer of coated one side paper, said bottom layer being bonded to the bottom surface of the middle layer by layer of bonding adhesive applied to the top surface of said bottom layer, to adhere to the middle layer of the tag material.

4. The tag material of claim 3 wherein said bottom layer is formed of a coated one side (C1S) paper.
